(19) United States
(12) Patent Application Publication
(10) Pub. No.: US 2006/0250788 A1
(43) Pub. Date: Nov. 9, 2006

(54) Adjustable downlight fixture

(76) Inventors: Michael Hodge, San Antonio, TX (US); Luke Bonecutter, San Antonio, TX (US)

Correspondence Address: Alan R. Thiele;Strasburger & Price, LLP, Suite 4400, 901 Main St., Dallas, TX, 75202, US

(21) Appl. No.: 11/402,669

(22) Filed: Apr. 12, 2006

Related U.S. Application Data
(60) Provisional application No. 60/670,491, filed on Apr. 12, 2005.

(51) Int. Cl. F21S 8/00

(52) U.S. Cl. 362/147

(57) ABSTRACT

An adjustable downlight fixture includes an adjustable mounting for a light source. The adjustable mounting for the light source may be rotated about a substantially vertical axis and tilted about a substantially horizontal axis from underneath the adjustable downlight fixture without having to remove the adjustable downlight fixture from its mounting within the ceiling.

The present invention claims priority from Provisional U.S. Patent Application Ser. No. 60/670,491 filed Apr. 12, 2005.

### FIELD

The present invention pertains to light fixtures mounted in a ceiling; more particularly, the present invention pertains to downlights in which the light source is aimed to illuminate a predetermined area or designated object.

### BACKGROUND

Interior designers continue to make use of lighting both to illuminate and to decorate a room. Such decoration often includes illumination of certain areas or illumination of certain objects which may be contained within the room. At the same time, interior designers want to minimize the size of the downlight fixtures to make them as unobtrusive as possible. Accordingly, there is continuing pressure on lighting designers to provide small unobtrusive downlight fixtures mounted through holes in the ceiling of a room which still provide the needed amount of light in desired locations.

To meet the needs of interior decorators, there remains a need in the art to provide small ceiling downlight fixtures which have a light source that can be aimed to direct light rays to the area or onto the object specified by an interior designer. Such aiming should be easy to do from underneath the fixture, without either dismantling the downlight fixture or removing the downlight fixture from the ceiling.

### SUMMARY

The disclosed adjustable downlight fixture includes a light source that can be aimed to an area or onto an object specified by an interior designer. In addition, the light source may be aimed from underneath the downlight fixture so that the path of the light rays emanating from the light source may be adjusted without dismantling the downlight fixture or removing the downlight fixture from the ceiling.

The light source of the present invention includes three major components. The first component is the trim ring. According to the present invention, the trim ring may be either substantially circular or substantially rectangular. Above the trim ring is a first mounting assembly for the light source, which enables rotation of the mounting for the light about a center line perpendicular to the trim ring and the ceiling. Above the first mounting assembly is a second mounting assembly which allows for tilting of the mounting for the light source, which allows for direction of the light rays angularly away from the light fixture.

### BRIEF DESCRIPTION OF THE DRAWINGS FIXTURES

A still better understanding of the disclosed adjustable downlight fixture may be had from the attached drawings figures wherein:

FIG. 1 is an exploded perspective view of the disclosed adjustable downlight fixture:

FIG. 2 is a side elevational view of an assembled adjustable downlight fixture with the light source aligned with a substantially vertical axis;

FIG. 3 is a right front perspective view of the disclosed adjustable downlight fixture with the mounting for the light source tilted to the rear of the adjustable downlight fixture;

FIG. 4 is a right front perspective view of the disclosed adjustable downlight fixture with the mounting for the light source tilted to the front of the adjustable downlight fixture;

FIG. 5 is a left front perspective view of a first alternate embodiment of the disclosed adjustable downlight fixture with the light source aligned with a substantially vertical axis;

FIG. 6 is a left from perspective view of the first alternate embodiment of the disclosed adjustable downlight fixture with the mounting for the light source tilted to the rear of the adjustable downlight fixture; and

FIG. 7 is a bottom plan view of the adjustable downlight fixture where the light source has been tilted to the rear of the adjustable downlight fixture.

### DESCRIPTION OF THE EMBODIMENTS

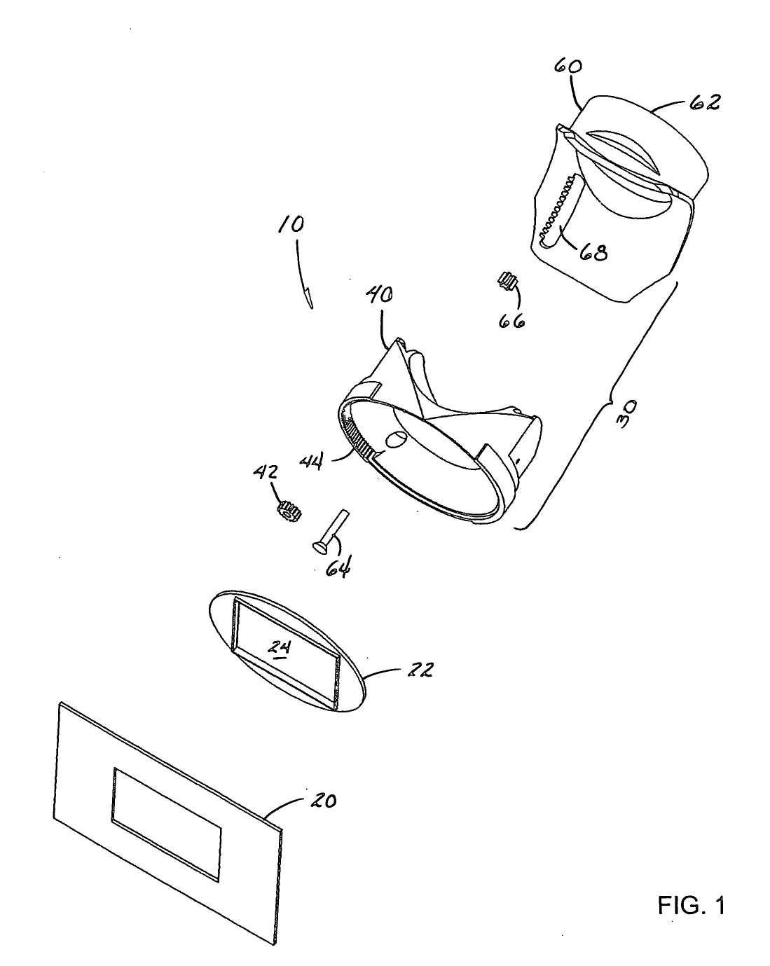

As shown in FIG. 1, the bottom of the adjustable light fixture 10 of the present invention is a substantially planar trim ring 20. The trim ring mounts 20 against the surface of the ceiling (not shown) and disguises the hole cut in the ceiling above which the adjustable light fixture 10 is mounted. The trim ring 20 may be square, as shown, or round. The trim ring may either have a round hole or a substantially square hole.

Above the trim ring is a baffle plate 22, The center opening 24 of the baffle plate 22 matches the opening in the trim ring 20.

Above the trim ring 20 is the first portion 40 of the light source mounting assembly 30. The first portion 40 of the light source mounting assembly 30 enables rotation of the light source 100 about the center of the trim ring 20; that is, around a substantially perpendicular axis extending upwardly from the trim ring 20 into the space above the ceiling. Rotation of the first portion 40 of the light source mounting assembly 30 is accomplished by reaching into the fixture 10 and simply turning the small gear 42 positioned just inside the fixture 10 with manual force. Turning the small gear 42 causes the external teeth thereon to engage the internal teeth on an arcuate gear segment 44 either mounted on or formed in the first portion 40 of the light source mounting assembly 30.

Above the first portion of the light source mounting assembly 30 is the second portion 60 of the light source mounting assembly 30. The second portion of the light source mounting assembly 30 has an upper circular opening 62 against with the light source 100 mounts. The second portion 60 of the light source mounting assembly 30 causes the light source 100 to tilt from side to side. Movement of the second portion 60 of the light source mounting assembly 30 is accomplished by using a small screwdriver to reach into the fixture 10 to turn a screw 64 attached to a second small gear 66. Turning of the second small gear 66 causes the external teeth thereon to engage the internal teeth on an arcuate gear segment 68 mounted on or formed in the second portion 60 of the light source mounting assembly 30. It is the second portion 60 of the light source mounting assembly 30 which allows the light source 100 to move from side to side.

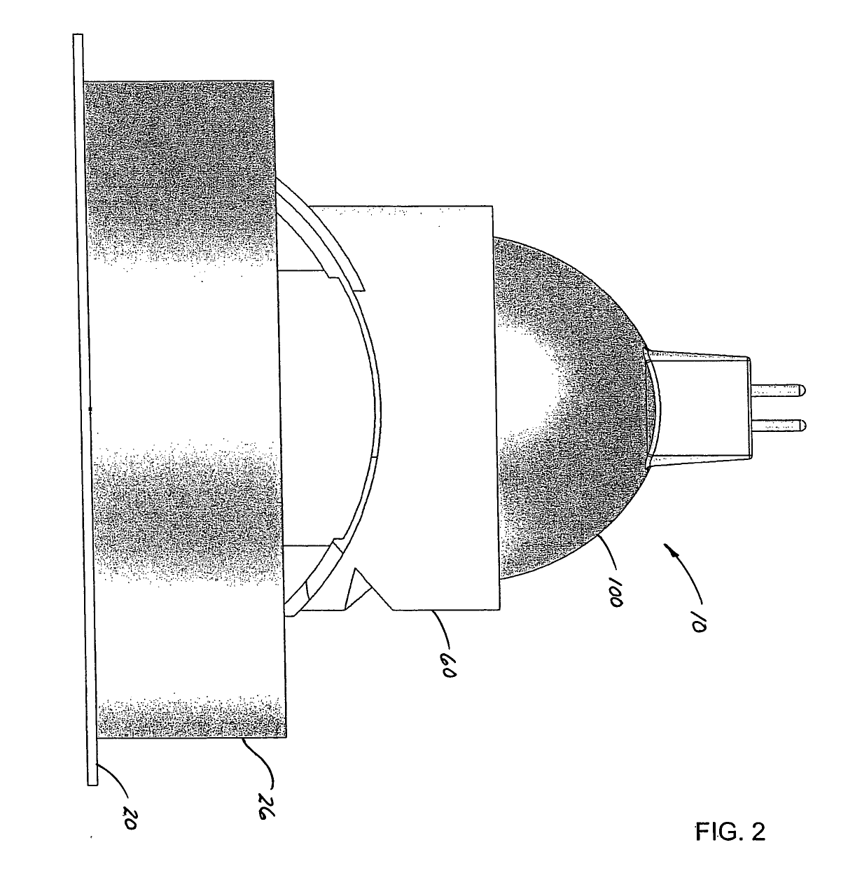

In FIG. 2, a side elevational view of the disclosed adjustable downlight fixture 10, shows the light source 100 aligned with the center line of the trim ring 20. In this configuration, the light from the light source 100 is directed directly downward. Extending upwardly from the trim ring is a shroud 26 which partially masks the lower portion of the first portion of the light source mounting assembly 30.

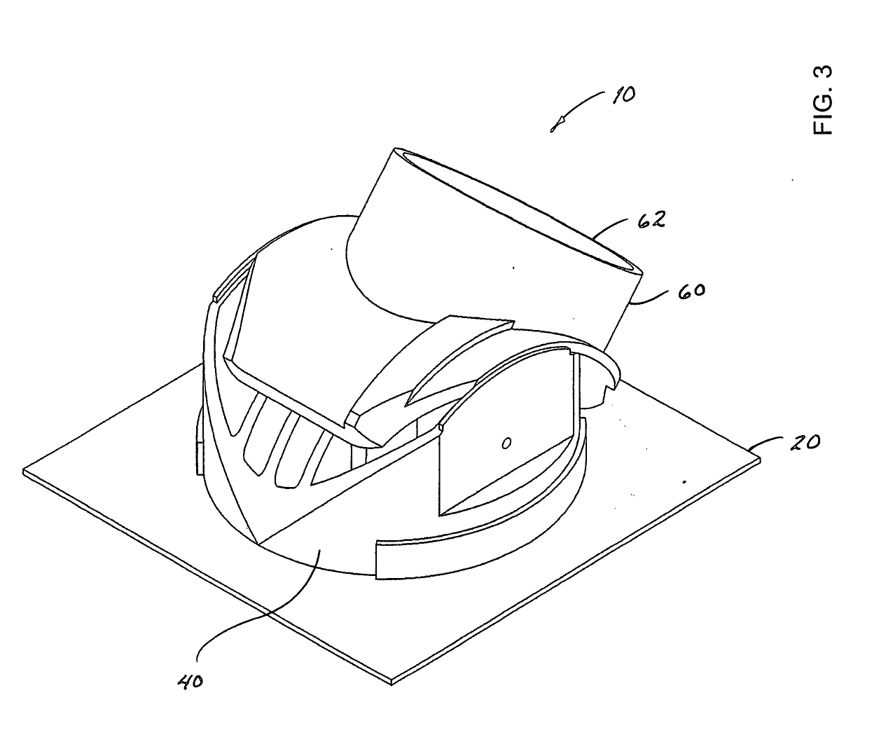

In FIG. 3, a perspective view of the disclosed adjustable downlight fixture shows the second portion 60 of the light source mounting assembly 30 tilted about 40 degrees to the rear of the downlight fixture 10 about a substantially horizontal axis. Such tilting will direct the light rays emanating from the light source 100 angularly with respect to the trim ring 20 and the ceiling.

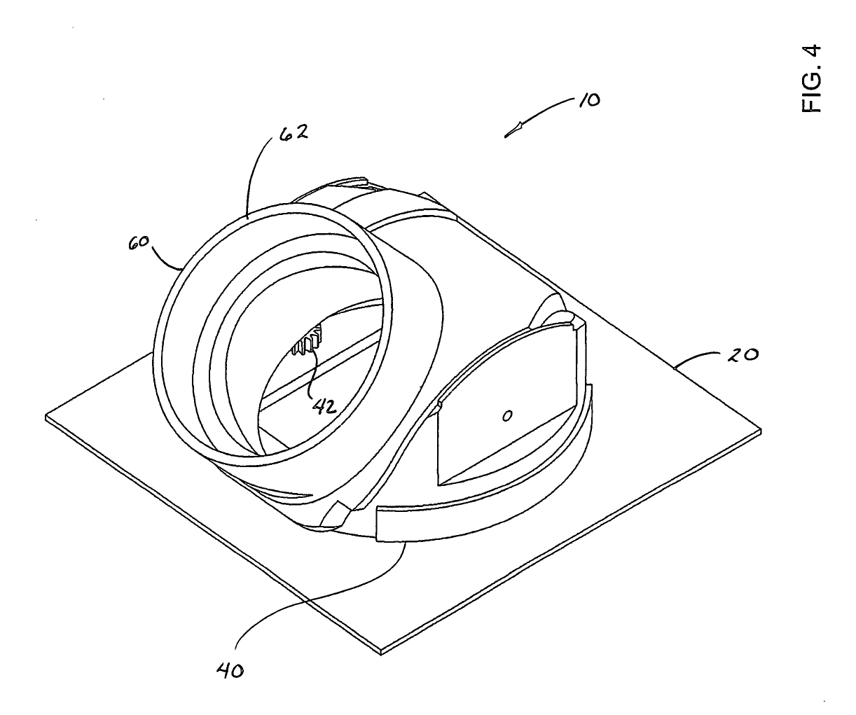

In FIG. 4, a second perspective view of the disclosed fixture 10 shows the second portion 60 of the light source mounting assembly 30 tilted about 40 degrees to the front of the downlight fixture 10. Such tilting will direct the light rays emanating from the light source 100 angularly with respect to the trim ring 20 and the ceiling but in an opposite direction to that shown in FIG. 3.

By comparing FIGS. 3 and 4 to FIG. 1, it will be seen that the tilting adjustment of the second portion 60 of the light source mounting assembly 30 is accomplished by inserting a screwdriver into the fixture 10 and turning the screw 64 attached to the small second gear 66.

In FIG. 4, the second portion 60 of the light source mounting assembly 30 is shown tilted to the front of the downlight fixture 10. If it is then desired to rotate the light source 100 to better aim the emanated light rays, all that is required is to reach up into the fixture to rotate the small gear 42 shown just above the trim ring 20. Such rotation of the small gear 42 will cause the first portion 40 of the light source mounting assembly 30 to rotate around an axis perpendicular to the trim ring 20.

Once the lighting fixture of the present invention has been installed, the light rays from the light source 100 are positioned as desired by the interior designer by tilting the second portion 60 of the light source mounting assembly 30 using a screwdriver to engage the screw head 64. If it is needed to further direct the light from the light source 100, the small gear 42 is turned by finger pressure.

While the friction between the internal and external teeth in the first portion 40 and second portion 60 of the light source mounting assembly 30 has proven sufficient to maintain the light source in the adjusted position, it may be necessary in some cases to uses some type of simple mechanical lock to lock the first porton 40 and the second portion 60 of the light source mounting assembly 30 in position.

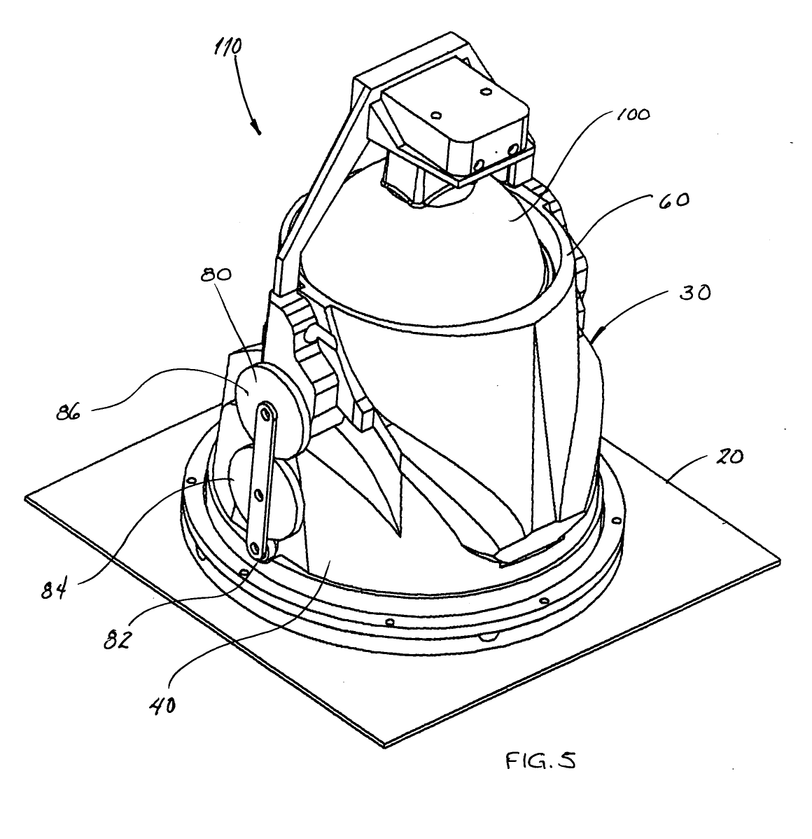

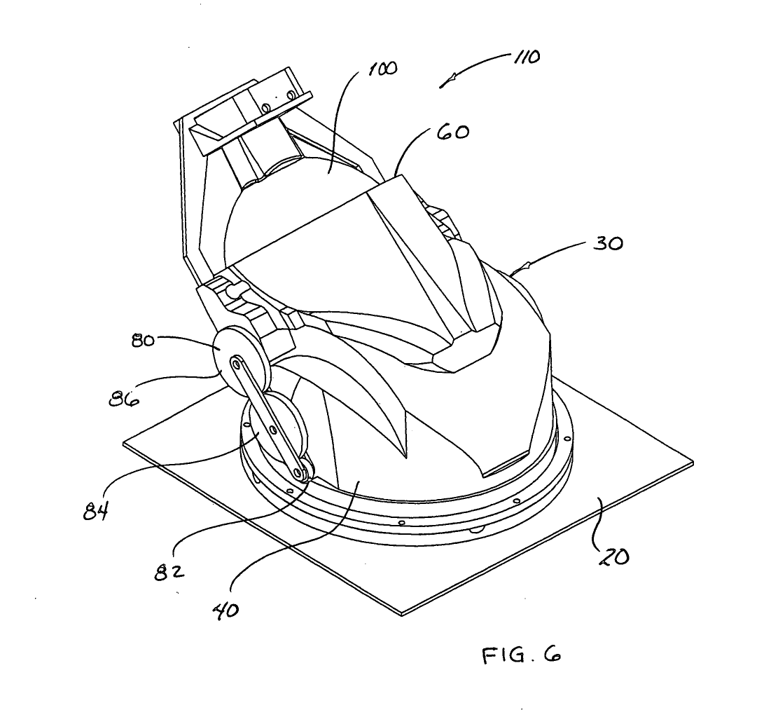

An alternate embodiment 110 of the disclosed adjustable downlight fixture is shown in FIG. 5 and in FIG. 6. The spur gear and arcuate gear rack used for tilting the adjustable light source mounting assembly 30 in the preferred embodiment described above has been replaced with a set of planetary friction wheels 80. A screw head accessible from underneath the downlight fixture is affixed to the inside portion of the lowest of the planetary friction wheels 82. Turning the lowest planetary friction wheel 82 causes the intermediate planetary friction wheel 84 to turn. The turning of the intermediate planetary friction wheel causes the top planetary friction wheel 84 to turn. It is the turning of the top planetary friction wheel 86 which causes the second portion 60 of the light source mounting assembly 30 to tilt about a substantially horizontal axis.

The rotation of the alternate embodiment 110 about a substantially vertical axis is accomplished in a manner similar to that described with respect to the preferred embodiment 10. Those of ordinary skill in the art will understand that a small tool such as a screw driver may be used to cause the adjustable mounting 30 to rotate about a substantially vertical axis.

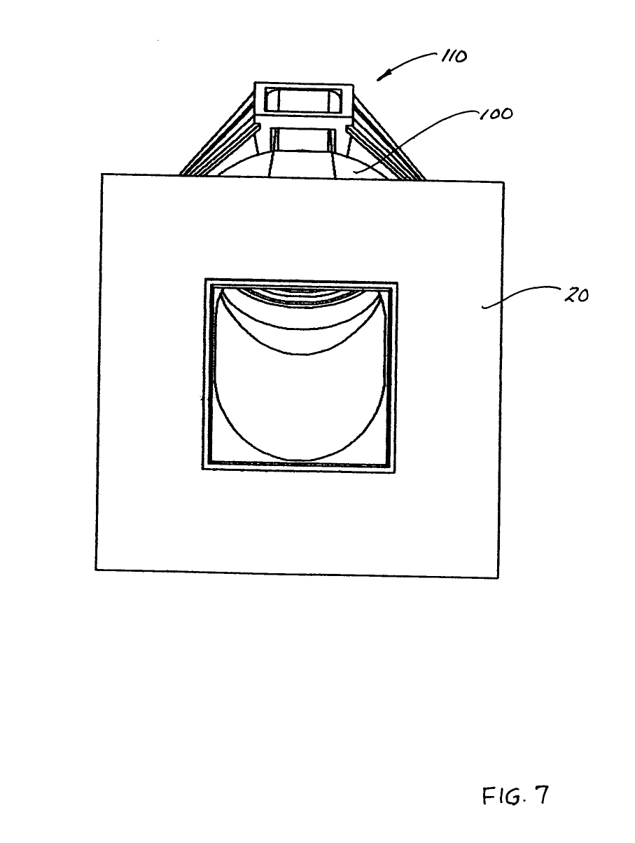

Shown within the trim ring 20 in FIG. 7 is what the occupant of a room below the ceiling will observe when looking into adjustable downlight fixture 10, 110 from under the ceiling. The position of the light source 100 in FIG. 7 is similar to that shown in FIGS. 3,4, and 6.

The advantages of the disclosed adjustable downlight fixture 10, 110 become most notable to interior decorators and room designers. Once the adjustable downlight fixture 10, 110 has been mounted in the ceiling portion of a room and the necessary electrical connections made, the interior decorator or room designer will want to assure that the light rays emanating from the light 100 source follow a path which provides the desired effect within the room. That effect may be the illumination of a wall, the illumination of a painting, the illumination of a statue, or the illumination of a piece of furniture. In prior art unadjustable downlight fixtures, paintings, statues, or furniture had to be located with respect to the light rays coming out of the downlight fixture. By using the disclosed invention, objects such as a painting, a statue or a piece of furniture are positioned within the room. The interior decorator or room designer then tilts the mounting 60 for the light source 100 so that the light rays follow a path toward the object to be illuminated. Then the interior decorator or room designer rotates the mounting 40 for the light source to place the light rays exactly where they can have the desired effect. Such tilting the second portion 60 of the mounting 30 for the light source 100 and rotating the mounting assembly 30 for the light source 100 is done while the adjustable downlight fixture 10, 110 is mounted to the ceiling.

If objects that have been in a room for awhile are removed and replaced with other objects, the interior decorator or room designer need only place the objects in their desired location and then take a small tool to move the light source with the disclosed adjustable downlight fixture of the present invention so that the desired lighting effects are obtained.

Those of ordinary skill in the art will understand that while the disclosed adjustable downlight fixture has been described according to its preferred and alternate embodiments, other embodiments have been enabled. Such other embodiments shall fall within the scope and meaning of the appended claims.

What is claimed is:

1. A downlight fixture constructed and arranged to be mounted through a hole in a ceiling, said downlight fixture comprising:
a light source;
a substantially planar trim ring constructed and arranged for contact with the ceiling;
an adjustable mounting for a light source positioned above said trim ring;
said adjustable mounting for a light source having a first mounting assembly permitting said light source to be rotated with respect to the center of said substantially planar trim ring;
said adjustable mounting for a light source having a second mounting assembly permitting said light source to be tilted with respect to the plane of said substantially planar trim ring;
whereby the light rays emitted by said light source may be aimed by both tilting and rotating said light source with respect to said substantially planar trim ring.

2. The downlight fixture as defined in claim 1 wherein said first mounting assembly includes a spur gear and an arcuate gear segment.

3. The downlight fixture as defined in claim 1 wherein said second mounting assembly includes a spur gear and an arcuate gear segment.

4. The downlight fixture as defined in claim 3 wherein said spur gear may be rotated by a screwdriver inserted into said adjustable mounting.

5. The downlight fixture as defined in claim 1 wherein said second mounting assembly includes a set of planetary friction wheels.

6. A downlight fixture for mounting in a ceiling, said downlight fixture permitting the aiming of the light rays emitted from a light source while said downlight fixture is mounted in the ceiling, said downlight fixture comprising:
a substantially circular adjustable mounting for the aimable light source, said adjustable mounting including:
a first portion constructed and arranged to rotate said substantially circular adjustable mounting around a substantially vertical axis;
a second portion constructed and arranged to rotate said substantially circular adjustable mounting around a substantially horizontal axis.

7. The downlight fixture as defined in claim 5 wherein said rotation about a substantially vertical axis is caused by the rotation of a spur gear against an arcuate gear section.

8. The downlight fixture as defined in claim 5 wherein said rotation about a substantially horizontal axis is caused by the rotation of a spur gear against an arcuate gear section.

9. The downlight fixture as defined in claim 7 wherein said spur gear may be rotated by the insertion of a screwdriver into said substantially circular adjustable mounting from below the downlight fixture.

10. The downlight fixture as defined in claim 5 wherein said rotation about a substantially horizontal axis is caused by the rotation of a set of planetary friction wheels.

11. A method of constructing a downlight fixture for mounting in a ceiling, said method comprising the steps of:
mounting a light source in an adjustable mounting assembly;
said adjustable mounting assembly enabling the movement of said light source around a substantially vertical axis and enabling the movement of movement of said light source around a substantially horizontal axis;
postioning mechanical controls to enable the movement of said light source around a substantially vertical axis and around said substantially horizontal axis to where said mechanical controls may be accessed from below the ceiling without removing the downlight fixture from the ceiling;
mounting a trim ring to said adjustable lighting assembly.

12. The method as defined in claim 10 wherein said movement of said adjustable mounting assembly around a substantially vertical axis is accomplished by the rotation of a spur gear against an arcuate gear segment.

13. The method as defined in claim 10 wherein said movement of said adjustable mounting assembly around a substantially horizontal axis is accomplished by the rotation of a spur gear against an arcuate gear segment.

14. The method as defined in claim 10 wherein said movement of said adjustable mounting assembly around a substantially horizontal axis is accomplished by the rotation of a set of planetary friction wheels.

15. A method of providing for the adjustment of the position of a light source in a downlight fixture mounted in a ceiling without removing the downlight fixture from the ceiling, said method comprising the steps of:
mounting an adjustable housing for the light source in a ring so that said adjustable housing is rotatable from underneath the downlight fixture;
including a pivot mounting in the adjustable housing for the light source so that said adjustable housing is pivotable from underneath the downlight fixture.

16. The method as defined in claim 14 wherein said rotation with respect to said ring is accomplished by the engagement of a spur gear with an arcuate gear segment mounted on said adjustable housing, said spur gear being accessible from underneath the downlight fixture.

17. The method as defined in claim 14 wherein said pivoting of said adjustable housing is accomplished by the engagement of a spur gear with an arcuate gear segment mounted on said adjustable housing, said spur gear being accessible from underneath the downlight fixture.

18. The method as defined in claim 14 wherein said pivoting of said adjustable housing is accomplished by rotation of a set of planetary friction wheels, said planetary friction wheels being rotatable from underneath the downlight fixture.
